(19) United States
(12) Patent Application Publication
(10) Pub. No.: US 2023/0419791 A1
(43) Pub. Date: Dec. 28, 2023

(54) NON-TRANSITORY COMPUTER READABLE MEDIUM, INFORMATION PROCESSING DEVICE, AND INFORMATION PROCESSING METHOD

(71) Applicant: JUNGLE X CORP., Tokyo (JP)

(72) Inventor: Fumitada NAOE, Tokyo (JP)

(73) Assignee: JUNGLE X CORP., Tokyo (JP)

(21) Appl. No.: 18/466,947

(22) Filed: Sep. 14, 2023

Related U.S. Application Data
(63) Continuation of application No. PCT/JP2022/007989, filed on Feb. 25, 2022.

(30) Foreign Application Priority Data
Apr. 9, 2021 (JP) 2021-066283

(51) Int. Cl. G07F 17/32; G06Q 50/34

(52) U.S. Cl. CPC G07F 17/3288; G06Q 50/34; G07F 17/323; G07F 17/3244

(57) ABSTRACT

A server 20 of an event information distribution system 1 includes, as functions thereof, a sports game type identification module 2033 for identifying a target sports game for which an input of event information is to be accepted, an event information acceptance module 2034 for accepting an input of an event which has occurred in a sports game, an event information evaluation module 2035 for evaluating the accepted event information, an event information distribution module 2036 for distributing event information based on an evaluation result, and a reward offering module 2038 for offering a prescribed reward to a user based on the evaluation result.

### CROSS-REFERENCE TO RELATED APPLICATIONS

This application is a Continuation Application of No. PCT/JP2022/007989, filed on Feb. 25, 2022, and the PCT application is based upon and claims the benefit of priority from Japanese Patent Application No. 2021-066283 filed on Apr. 9, 2021, the entire contents of which are incorporated herein by reference.

### FIELD

Embodiments described herein relate generally to a program, an information processing device, and a method.

### BACKGROUND

With respect to sports games, it has been conventionally performed to collect and distribute information on events occurring in the sports games in real time. For example, a method is used in which a data collector watching a sports game directly or watching a live video inputs the situation of the sports game manually, or a method in which a live video is analyzed and the situation of a sports game is interpreted by a predetermined algorithm.

Patent Literature 1 discloses an image display technique for displaying a multi-viewpoint video of a sports game. In this image display, images obtained by imaging the same space from multiple viewpoints, such as images of each player in a soccer game, are virtually generated and distributed.

The method for collecting event information by a data collector watching a sports game is troublesome because it is necessary to manually input the situation of the sports game. Further, when event information is collected using a live video, it is assumed that the sports game will be broadcasted. However, since minor sports and minor games are not broadcasted in many cases, it is necessary to dispatch data collectors to the venues where the sports games are held, which incurs manpower costs. Therefore, a technique for collecting information on sports games at low cost has been desired.

Therefore, in the present disclosure, a technique for efficiently collecting and distributing information on sports games will be described.

### BRIEF DESCRIPTION OF THE DRAWINGS

FIG. 1 is a configuration diagram showing an overall configuration of an event information distribution system 1.

FIG. 2 is a block diagram showing a functional configuration of a terminal device 10 constituting the event information distribution system 1 of a first embodiment.

FIG. 3 is a block diagram showing a functional configuration of a server 20 constituting the event information distribution system 1 of the first embodiment.

FIG. 4 is a conceptual diagram showing a content of a distributed ledger 31 constituting the event information distribution system 1 of the first embodiment.

FIG. 5 is a diagram showing data structures of a sports game database 2021 and an event database 2022 that are stored by the server 20.

FIG. 6 is a diagram showing a data structure of a user database 2023 stored by the server 20.

FIG. 7 is a flowchart showing an example of a flow of event information distribution processing by the event information distribution system 1 of the first embodiment.

FIG. 8 is a flowchart showing another example of the flow of the event information distribution processing by the event information distribution system 1 of the first embodiment.

FIG. 9 is a diagram showing an example of an input screen of an event occurrence position to be displayed on the terminal device 10.

FIG. 10 is a diagram showing an example of an input screen of event information to be displayed on the terminal device 10.

FIG. 11 is a diagram showing a functional configuration of a server 20 constituting an event information distribution system 1 of a second embodiment.

FIG. 12 is a diagram showing a functional configuration of a server 20 constituting an event information distribution system 1 of a third embodiment.

### DETAILED DESCRIPTION

In general, according to one embodiment, there is provided a non-transitory computer readable medium that stores a program to collect and distribute information on sports games. The medium stores processing of identifying a target sports game; processing of accepting an input of information on an event that has occurred in the sports game, from a terminal device of a user who is watching the sports game; processing of evaluating the accepted event information; processing of distributing the event information based on an evaluation result of the event information; and processing of offering a reward to a user who has input the event information, based on the evaluation result of the event information.

Embodiments of the present disclosure will be described hereunder with reference to the drawings. In the following description, the same parts are given the same reference signs. The names and functions thereof are also the same. Therefore, detailed description thereof will not be repeated.

### <Overview>

An event information distribution system according to the present disclosure will be described below. The event information distribution system is a system for accepting an input of information on an event that has occurred in a sports game from a terminal device of a user who is watching the sports game, and evaluating and distributing the accepted event information. Here, the event information is information indicating actions of players and results brought by those actions in the sports game, for example, information on actions such as hit, home run, and out in baseball, and shoot, goal, and shoot save in soccer. Further, the event information also includes information on a time, a place, and a subject such as when an action has occurred in the event, where the action has occurred on the ground, and who (or team) has taken the action. In other words, the event information distribution system is a system for performing data collection based on information input from users who are actually watching the competition in order to collect and distribute real-time data related to sports.

The event information distribution system is configured such that event information can be easily input from a user's portable terminal such as a smartphone so that a user who is actually watching the competition is caused to input the event information. Specifically, the event information distribution system is configured such that a list is displayed on a screen for identifying a target sports game and inputting event information, and the user can input by simply tapping and selecting on the screen.

In order to ensure the accuracy of information to be distributed in such an event information distribution system, information to be collected is required to be accurate. Therefore, in the event information distribution system according to the present disclosure, event information from a plurality of users is collected, and if a collection result meets a first evaluation criterion, the event information is evaluated as correct. On the other hand, when the collection result does not reach the first evaluation criterion, an input of an answer on the correctness of the event information (questioning whether the event information is correct or incorrect, and an answer thereto) is accepted, and when the answer result reaches a second evaluation criterion, the event information is evaluated as correct.

Specifically, for users who have input event information, that is, users who use the event information distribution system, the users are ranked based on the accuracy of past event information. When event information input by a plurality of users are evaluated, the user are provided with points corresponding to ranks thereof (the higher the rank, the more points), and the points of the users who have input the collected event information are totaled. When the total value of the points reaches a first threshold value which is the first evaluation criterion, the event information is evaluated as correct. Further, when the total value of points does not reach the first threshold value, an input of an answer on correctness of the event information is accepted, and the points of users who have input the answers are totaled. When the total value of the points reaches a second threshold value which is the second evaluation criterion, the event information is evaluated as correct. By adopting such a configuration, on the premise that users who have input accurate information in the past may highly possibly input accurate information at present and in the future as well, the influence of such users' input information is made strong, thereby aiming at collection of accurate information.

Further, as an incentive for users who have input accurate information, prescribed rewards are offered to users who have input event information evaluated as correct and users who have input answers on the correctness of event information evaluated as correct. The rewards are recorded, for example, as tokens on a blockchain, and are exchangeable for legal tenders. The reward to be offered at this time is also offered according to the user's rank (the higher the rank, the greater the reward). In addition, the user's rank is moved up. Such a configuration makes it possible to expect an input of accurate information.

Note that in the event information distribution system, as information to complement information event to be selected by a user, or as information to complement real-time data related to sports to be distributed, for example, it is possible to fly a flying object such as a drone at a venue where a sports game is held to image a competition situation, or to image the competition situation with a camera installed in the venue and acquire captured image data. Further, it is possible to embed devices (NFC tags, Beacon devices, etc.) for transmitting position information in uniforms of athletes participating in a sports game and acquire the position information of the athletes in the venue. When a user selects event information, these position information may be presented, or when the event information is delivered, the event information may be delivered together with the position information, whereby the accuracy of event information can be ensured.

### First Embodiment

The event information distribution system 1 will be described below. In the following description, for example, upon access of a terminal device 10 to a server 20, the server 20 responds with information for generating a screen on the terminal device 10. The terminal device 10 generates and displays a screen based on the information received from the server 20.

### <1 Overall Configuration of Event Information Distribution System 1>

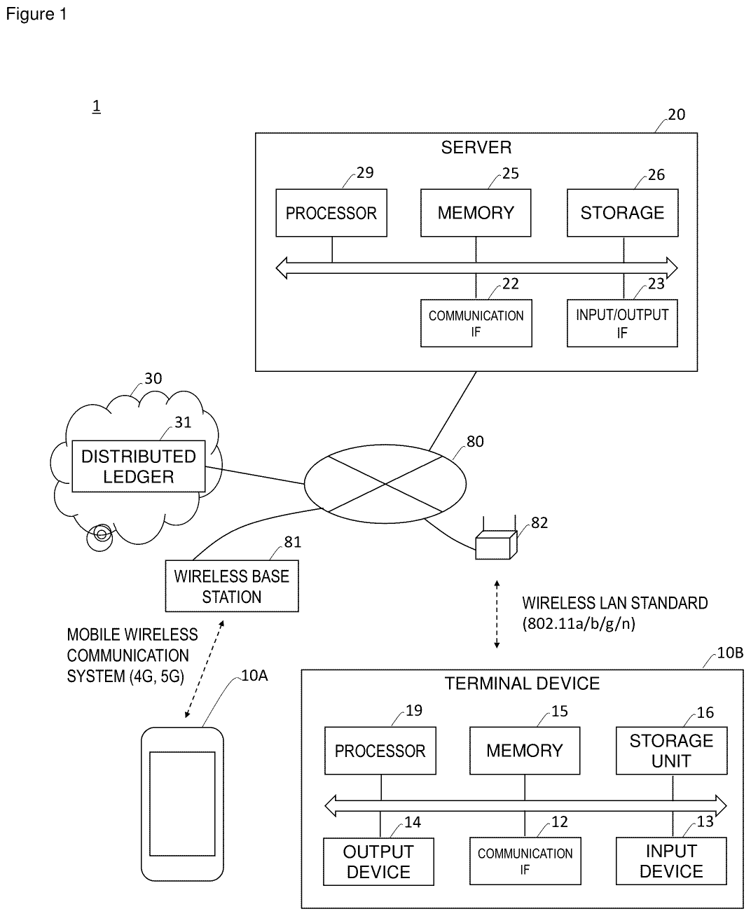

FIG. 1 is a configuration diagram showing an overall configuration of the event information distribution system 1. As shown in FIG. 1, the event information distribution system 1 includes a plurality of terminal devices (a terminal device 10A and a terminal device 10B are shown in FIG. 1. Hereinafter, they may be collectively referred to as the “terminal device 10”), the server 20, and a blockchain distributed network 30. The terminal device 10 and the server 20 are mutually communicably connected to each other via a network 80. The server 20 and the blockchain distributed network 30 are mutually communicably connected to each other via the network 80. The network 80 is configured by a wired or wireless network.

The terminal device 10 is a device to be operated by each user. The terminal device 10 is implemented by a mobile terminal such as a smartphone or a tablet adaptable to a mobile communication system. In addition, the terminal device 10 may be, for example, a portable notebook PC (personal computer) or a laptop PC. The user who operates the terminal device 10 is a person who watches a sports game and inputs event information in the event information distribution system 1, for example, a person who is registered as a member of the event information distribution system 1.

The terminal device 10 is communicably connected to the server 20 via the network 80. The terminal device 10 is connected to the network 80 by communicating with communication devices such as a wireless base station 81 adaptable to communication standards such as 4G, 5G, and LTE (long term evolution), and a wireless LAN router 82 adaptable to a wireless LAN (local area network) standard such as IEEE (Institute of Electrical and Electronics Engineers) 802.11. As shown as the terminal device 10B in FIG. 1, the terminal device 10 includes a communication IF (interface) 12, an input device 13, an output device 14, a memory 15, a storage unit 16, and a processor 19.

The communication IF 12 is an interface for inputting and outputting signals so that the terminal device 10 communicates with an external device. The input device 13 is an input device (for example, a touch panel, a touch pad, a keyboard, a pointing device such as a mouse, etc.) for accepting an input operation from a user. The output device 14 is an output device (a display, a speaker, etc.) for presenting information to the user. The memory 15 temporarily stores programs and data to be processed by the programs, and is a volatile memory such as a DRAM (dynamic random access memory). The storage unit 16 is a storage device for storing data, and is, for example, a flash memory or an HDD (hard disc drive). The processor 19 is hardware for executing a command set described in a program, and is configured by an arithmetic device, a register, a peripheral circuit, and the like.

The server 20 is a device for accepting an input of event information from a user, evaluating the event information, and then distributing the event information. The server 20 ranks users based on the evaluation of event information accepted from the users, and provides rewards corresponding to the ranks of the users.

The server 20 is a computer connected to the network 80. The server 20 includes a communication IF 22, an input/output IF 23, a memory 25, a storage 26, and a processor 29.

The communication IF 22 is an interface for inputting and outputting signals so that the server 20 communicates with an external device. The input/output IF 23 functions as an interface with an input device for accepting input operations from users and an output device for presenting information to the users. The memory 25 temporarily stores programs and data to be processed by the programs, and is a volatile memory such as a DRAM (dynamic random access memory). The storage 26 is a storage device for storing data, such as a flash memory or an HDD (hard disc drive). The processor 29 is hardware for executing a command set described in a program, and is configured by an arithmetic device, a register, a peripheral circuit, and the like.

The blockchain distributed network 30 is a device for managing prescribed rewards for users. Blockchain software capable of implementing a smart contract such as Ethereum is used as the blockchain distributed network 30, and the prescribed rewards are managed as tokens on the blockchain using a blockchain technique. The blockchain distributed network 30 is provided with the distributed ledger 31 for management using the blockchain technique.

### <1.1 Configuration of Terminal Device 10>

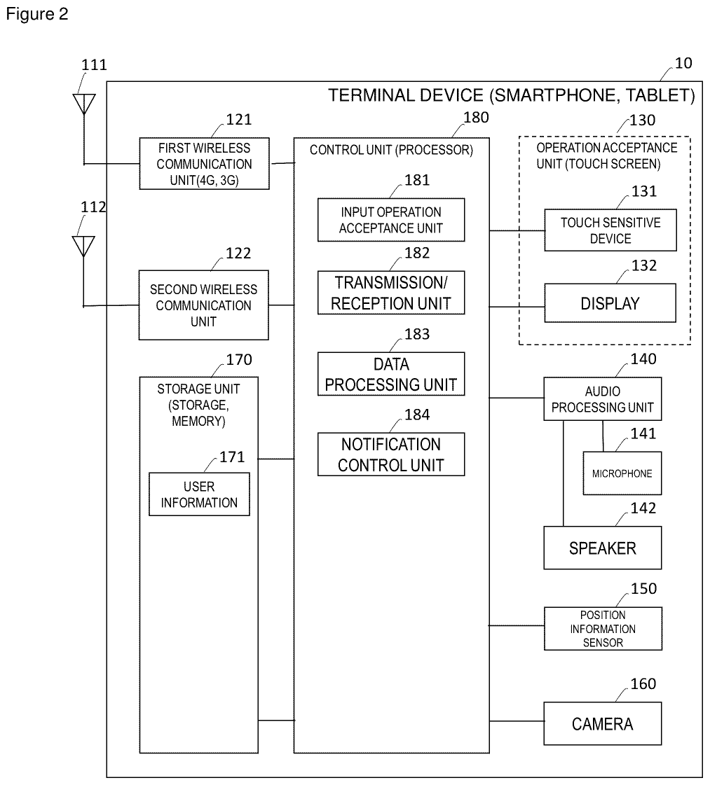

FIG. 2 is a block diagram showing a functional configuration of the terminal device 10 constituting the event information distribution system 1 of the first embodiment. As shown in FIG. 2, the terminal device 10 includes a plurality of antennas (an antenna 111, an antenna 112), wireless communication units (a first wireless communication unit 121, a second wireless communication unit 122) corresponding to the respective antennas, an operation acceptance unit 130 (including a touch-sensitive device 131 and a display 132), an audio processing unit 140, a microphone 141, a speaker 142, a position information sensor 150, a camera 160, a storage unit 170, and a control unit 180. The terminal device 10 also has functions and configurations not particularly shown in FIG. 2 (for example, a battery for retaining electric power, a power supply circuit for controlling power supply from the battery to respective circuits, etc.). As shown in FIG. 2, the respective blocks included in the terminal device 10 are electrically connected to one another by a bus or the like.

The antenna 111 radiates a signal emitted by the terminal device 10 as radio waves. The antenna 111 also receives radio waves from space and provides a reception signal to the first wireless communication unit 121.

The antenna 112 radiates a signal emitted by the terminal device 10 as radio waves. The antenna 112 also receives radio waves from space and provides a reception signal to the second wireless communication unit 122.

The first wireless communication unit 121 performs modulation/demodulation processing and the like for transmitting and receiving signals via the antenna 111 so that the terminal device 10 communicates with other wireless devices. The second wireless communication unit 122 performs modulation/demodulation processing and the like for transmitting and receiving signals via the antenna 112 so that the terminal device 10 communicates with other wireless devices. The first wireless communication unit 121 and the second wireless communication unit 122 are communication modules each including a tuner, an RSSI (received signal strength indicator) calculation circuit, a CRC (cyclic redundancy check) calculation circuit, a high frequency circuit, and the like. The first wireless communication unit 121 and the second wireless communication unit 122 perform modulation/demodulation and frequency conversion of radio signals transmitted/received by the terminal device 10, and provide reception signals to the control unit 180.

The operation acceptance unit 130 has a mechanism for accepting a user's input operation. Specifically, the operation acceptance unit 130 is configured as a touch screen, and includes the touch-sensitive device 131 and the display 132. Note that the operation acceptance unit 130 may be configured by, for example, a keyboard, a mouse, and the like.

The touch-sensitive device 131 receives an input operation of the user of the terminal device 10. The touch-sensitive device 131 detects a user's touch position on the touch panel by using, for example, a capacitance touch panel. The touch-sensitive device 131 outputs a signal indicating the user's touch position detected by the touch panel to the control unit 180 as an input operation.

The display 132 displays data such as images, videos, and texts under the control of the control unit 180. The display 132 is implemented by, for example, an LCD (liquid crystal display) or an organic EL (electro-luminescence) display.

The audio processing unit 140 modulates and demodulates audio signals. The audio processing unit 140 modulates a signal supplied from the microphone 141 and supplies the modulated signal to the control unit 180. Further, the audio processing unit 140 supplies an audio signal to the speaker 142. The audio processing unit 140 is implemented by, for example, a processor for audio processing. The microphone 141 receives an audio input, and supplies an audio signal corresponding to the audio input to the audio processing unit 140. The speaker 142 converts the audio signal supplied from the audio processing unit 140 into audio, and outputs the audio to the outside of the terminal device 10.

The position information sensor 150 is a sensor for detecting the position of the terminal device 10, and is, for example, a GPS (global positioning system) module. The GPS module is a receiving device to be used in a satellite positioning system. The satellite positioning system receives signals from at least three or four satellites, and detects the current position of the terminal device 10 having the GPS module installed therein based on the received signals.

The camera 160 is a device for receiving light with a light receiving element and outputting it as a captured image. The camera 160 is, for example, a depth camera that can detect a distance from the camera 160 to an object to be imaged.

The storage unit 170 is configured by, for example, a flash memory or the like, and stores data and programs to be used by the terminal device 10. In one aspect, the storage unit 170 stores user information 171.

The user information 171 is information on a user who uses the terminal device 10 to input event information, which is a function of the event information distribution system 1, and obtains a reward. The user information includes information for identifying the user (user ID), a password, information such as the name or appellation of the user, and the like.

The control unit 180 reads a program stored in the storage unit 170 and executes commands included in the program, thereby controlling the operation of the terminal device 10. The control unit 180 is, for example, an application pre-installed in the terminal device 10. The control unit 180 operates according to programs to function as an input operation acceptance unit 181, a transmission/reception unit 182, a data processing unit 183, and a notification control unit 184.

The input operation acceptance unit 181 performs processing for accepting a user's input operation to the input device such as the touch-sensitive device 131. The input operation acceptance unit 181 determines which type of operation the user's operation is, from among a flick operation, a tap operation, or a drag (swipe) operation, based on information on the coordinates where the user touches the touch-sensitive device 131 with his or her finger or the like.

The transmission/reception unit 182 performs processing for allowing the terminal device 10 to transmit and receive data to and from an external device such as the server 20 according to a communication protocol.

The data processing unit 183 performs processing of performing an arithmetic operation on data whose input is accepted by the terminal device 10 according to a program, and outputting an arithmetic operation result to the memory or the like.

The notification control unit 184 performs processing for presenting information to the user. The notification control unit 184 performs processing for causing the display 132 to display a display image thereon, processing for causing the speaker 142 to output audio therefrom, processing for causing the camera 160 to vibrate, and the like.

### <1.2 Functional Configuration of Server 20>

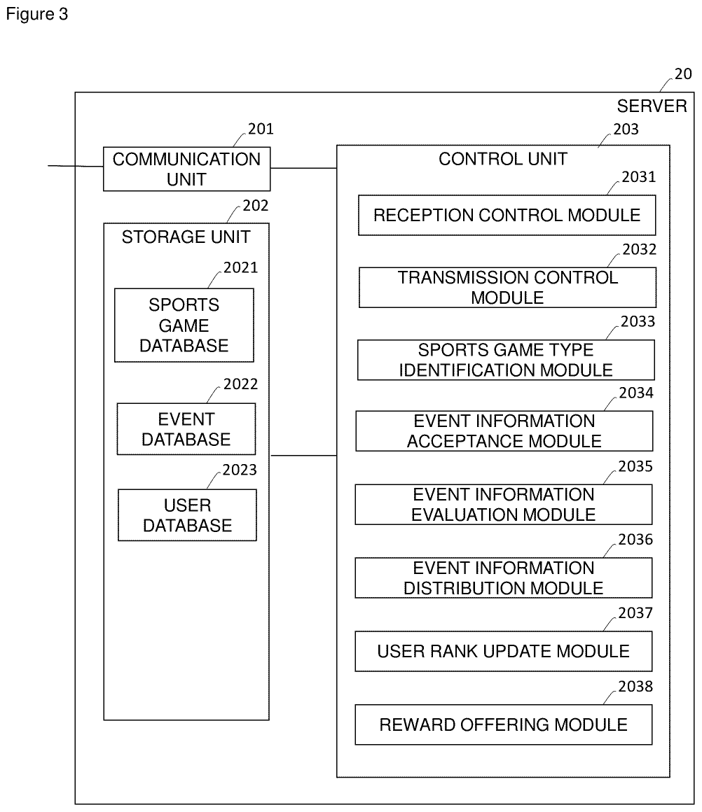

FIG. 3 is a block diagram showing a functional configuration of the server 20 constituting the event information distribution system 1 of the first embodiment. As shown in FIG. 3, the server 20 exercises functions as a communication unit 201, a storage unit 202 and a control unit 203.

The communication unit 201 performs processing for allowing the server 20 to communicate with an external device.

The storage unit 202 stores data and programs to be used by the server 20. The storage unit 202 stores a sports game database 2021, an event database 2022, a user database 2023, and the like.

The sports game database 2021 is a database for holding information on sports games which are scheduled to be held and targeted to be collected as event information in the event information distribution system 1. Details thereof will be described later.

The event database 2022 is a database for holding information indicating the actions of players in sports games and results caused by those actions, which are contents of event information to be collected in the event information distribution system 1. For example, the contents are categorized and stored according to the types of sports games. Details thereof will be described later.

The user database 2023 is a database for holding information on users who input event information in the event information distribution system 1. Details thereof will be described later.

Upon execution of processing according to a program by the processor of the server 20, the control unit 203 exercises functions indicated by various modules such as an reception control module 2031, a transmission control module 2032, a sports game type identification module 2033, an event information acceptance module 2034, an event information evaluation module 2035, an event information distribution module 2036, a user rank update module 2037, and a reward offering module 2038.

The reception control module 2031 controls processing for allowing the server 20 to receive signals from external devices according to a communication protocol.

The transmission control module 2032 controls processing for allowing the server 20 to transmit signals to external devices according to a communication protocol.

The sports game type identification module 2033 controls processing for identifying a sports game for which an input of event information is accepted. A sports game to be identified by the sports game type identification module 2033 is identified in such a state that it can be objectively identified as a sports game or a competition when and where the sports game or the competition is held and which players (teams) participate in the sports game or the competition. For example, the sports game type identification module 2033 may transmit, to the terminal device 10, information on sports games scheduled to be held and stored in the sports game database 2021 to present the information to the user, and identify a sports game based on user's selection, or may identify by accepting information on a sports game which is directly input by the user through the terminal device 10. Further, when information on sports games scheduled to be held is presented to the user, the sports game type identification module 2033 may select a sports game to be held immediately from the current time, and present the selected sports game to the user.

The sports game type identification module 2033 may receive information on sports games scheduled to be watched from a user and register the information in advance, and when a start time approaches, the sports game type identification module 2033 may present the information on the sports games to the user (for example, service providing application software of the event information distribution system 1 automatically starts and presents), and identify a sports game based on user's input. Further, the sports game type identification module 2033 may be interlocked with a sales system for tickets, etc., for watching sports games in the event information distribution system 1, and identify sports games from information on tickets or the like purchased by users. Further, the sports game type identification module 2033 may transmit information on sports games to the users' terminal devices and make recommendations based on information on sports games that the users have watched in the past. With this configuration, it is possible to recommend sports games that meet the users' tastes, and, as described later, allow users (with high rank) capable of inputting correct event information to participate in sports game venues, whereby it is possible to secure the input of accurate event information.

The event information acceptance module 2034 controls processing for accepting an input of information on an event that has occurred in a sports game specified by the sports game type identification module 2033 from the terminal device 10 of a user watching the sports game. As described above, the event information accepted by the event information acceptance module 2034 is information indicating the actions of players and teams in sports games and the results caused by those actions, and for example, information on actions such as hits, home runs and outs in baseball, etc. For example, the event information acceptance module 2034 may transmit event information stored in the event database 2022 for an identified sports game to the terminal device 10 to present the information to the user, and receive event information according to the user's selection, or may receive event information which is directly input through the terminal device 10 by the user.

The event information acceptance module 2034 may also receive event information linked to information on one event selected by the user. For example, if the information on one event selected by the user is “shoot” in a soccer game, the linked event information is information about a player who made the shoot, information for selecting where the shoot was made in the competition venue, whether the result of the shoot is a goal, whether the ball flew out of bounds, or whether the shoot was saved by the keeper, etc. The number of pieces of linked event information may be one or multiple.

Furthermore, the event information acceptance module 2034 may acquire, as information for complementing event information to be selected by the user, captured image data obtained by imaging the competition situation from an external device such as a drone or a camera, and transmit the information to the terminal device 10 to present the information to the user, or may acquire position information obtained from devices (NFC tags, Beacon devices, or the like) embedded in players' uniforms or the like to send position information, and transmit the position information to the terminal device 10 to present the position information to the user. The user may check this captured image data and the position information to identify the position information indicating where the event related to the input event information was held, the positions and relationship of players, etc., related to the event (for example, a player tackled another player or the like), and the like. Further, the event information acceptance module 2034 may analyze the captured image data and the position information, predict the development of the competition using a machine learning model or the like based on the positions and relationship of players, etc., predict events that may occur in the future, and presents them as options to the user. This makes it easier for users to input event information, and can ensure the accuracy of event information.

The event information evaluation module 2035 controls processing of evaluating the event information accepted by the event information acceptance module 2034. The evaluation of event information to be performed by the event information evaluation module 2035 is to evaluate whether or not the input event information is different from an event that actually occurred, that is, whether or not the input event information is correct. In the evaluation of event information by the event information evaluation module 2035, for example, when a plurality of users of a predetermined ratio or more out of a plurality of users have input information on an event, the information on the event is evaluated as correct.

Further, the evaluation of event information by the event information evaluation module 2035 is performed, for example, as follows. The event information evaluation module 2035 collects event information accepted by the event information acceptance module 2034 from a plurality of users, and evaluates (establishes) the event information as correct when the collection result reaches the first evaluation criterion. When the collection result does not reach the first evaluation criterion, the event information evaluation module 2035 sends, to the terminal device 10, an answer on the correctness of the event information, specifically a question as to whether the event information is correct or incorrect, receives an input of an answer thereof, and evaluates (establishes) the event information as correct when the answer result reaches the second evaluation criterion.

Whether the first evaluation criterion and the second evaluation criterion are reached is determined, for example, as follows. As described above, users who have input event information, that is, users who use the event information distribution system are ranked based on the accuracy of past event information, and are stored in the user database 2023, for example. When evaluating event information input by a plurality of users, the event information evaluation module 2035 gives points corresponding to the users' ranks (the higher the rank, the more points), and the points of the users who have input the collected event information are totaled (calculated). When the total value of the points reaches the first threshold which is the first evaluation criterion, the event information concerned is evaluated as correct.

When the total value of the points does not reach the first threshold value, a question as to whether the event information is correct or incorrect is transmitted to the terminal devices 10, the input of answers is accepted from the users, and the points of the users who have input the answers is totaled (calculated). When the total value of the points reaches the second threshold value which is the second evaluation criterion, the event information concerned is evaluated as correct. At this time, the users of the terminal devices 10 to which the question as to whether the event information is correct or incorrect is sent may be limited to those users who did not input the event information, or the question may be sent to all users who are watching the sports game. Note that the points of the users may be totaled by simply adding the points, or may be totaled while performing weighting or the like according to a certain standard.

Since users who are watching a sports game identified by the sports game type identification module 2033 can be grasped, for example, the points of all users who are watching the sports game may be totaled, and the first threshold value and the second threshold value may be set as percentages of the total value.

Here, the points corresponding to the ranks of users are totaled with respect to users who have input collected event information because it is considered that users having high ranks are users who have input accurate information in the past, and such users may highly possibly input accurate information at present and in the future as well. Based on such a premise, the influence of the input of event information is made strong for the users having high ranks, thereby aiming at collection of accurate information.

The first threshold value and the second threshold value are set according to a content of distribution of event information by the event information distribution module 2036 which is described later. For example, when promptness of distribution of event information is emphasized, the first threshold value and the second threshold value may be set to be low in order to make it easier to evaluate event information as correct. When accurateness is emphasized, the first threshold value and the second threshold value may be set to be high in order to make it difficult to evaluate (in order to strictly evaluate) event information as correct. Further, the first threshold value and the second threshold value may be set to different values depending on the characteristics of the sports games and the types of event information. This is because it is considered that whether users can select correct event information is different depending on various factors such as whether a user group is familiar with watching the sports game, the degree of difficulty of determination based on the type of event information, and the scale of the sports game.

The event information evaluation module 2035 may determine the evaluation of event information as described above by using a machine learning model. Such a machine learning model may be created by machine learning performed as a function of the event information evaluation module 2035, or a machine learning model created as a result of machine learning performed by another device may be acquired. Such machine learning may be performed by supervised machine learning using predetermined teaching data, may be performed by unsupervised machine learning, or may be performed by deep learning. Further, it is possible to perform aggregation processing for comparing an evaluation result by the event information evaluation module 2035 with a content of an event that actually occurred and become clear later, and merging a learning result by further machine learning.

The event information distribution module 2036 controls processing for distributing event information based on the evaluation result by the event information evaluation module 2035. Distribution destinations to which the event information distribution module 2036 distributes event information may be an unspecified number of users, or may be limited to those users who have been registered as members in the event information distribution system 1. The event information distribution module 2036 distributes event information which has been evaluated as correct based on the evaluation result by the event information evaluation module 2035. However, when promptness is emphasized, the event information may be distributed before the evaluation based on the first evaluation criterion and the second evaluation criterion is settled. Further, for example, When event information which has been distributed once is turned out to be incorrect, corrected event information may be distributed later.

For example, the event information distribution module 2036 may distribute event information evaluated as correct in a form of documented text information obtained by processing the event information so that a user to which it is distributed can read. Further, one piece of event information and event information linked thereto may be integrated with each other and processed, and distributed in the form of documented text information. At this time, the event information may be documented by combining words set as the event information and other structured words.

Further, the event information distribution module 2036 may acquire, for example, captured image data obtained by imaging a competition situation from an external device such as a drone, for example, as information for complementing real-time data related to sports to be distributed, and transmit the captured image data to the terminal device 10 to present the captured image data to the user, or may acquire position information obtained from devices (NFC tags, Beacon devices or the like) which are embedded in players' uniforms or the like to transmit position information, and send the position information to the terminal device 10 to present the position information to the user. As a result, it is possible to complement event information to be distributed.

The user rank update module 2037 controls processing for updating the user's rank based on the evaluation result by the event information evaluation module 2035. Specifically, for users who have input event information evaluated as correct by the event information evaluation module 2035 and users who have input correct answers to a question from the event information evaluation module 2035 as to whether the event information is correct or incorrect, the user rank update module 2037 increase the points which have been given to the users. Further, For users who have input event information that was not evaluated as correct by the event information evaluation module 2035 and users who have input incorrect answers to a question from the event information evaluation module 2035 as to whether the event information is correct or incorrect, the user rank update module 2037 decreases the points which have been given to the users. The users are ranked again according to the points increased or decreased through this processing. As a result, ranking reflecting the contents of the event information by the users in the sports game is performed, and it is reflected in the evaluation of event information from the next time onward.

The user rank update module 2037 updates the user database 2023 with respect to the increased or decreased points and ranks.

The reward offering module 2038 controls processing for offering prescribed rewards to users based on evaluation results by the event information evaluation module 2035. Specifically, prescribed rewards are given to users who have input event information evaluated as correct by the event information evaluation module 2035 and users who have input correct answers to a question from the event information evaluation module 2035 as to whether the event information is correct or incorrect.

The rewards to be offered by the reward offering module 2038 may be recorded as tokens on the blockchain. Tokens may also be exchangeable for legal tenders. Further, with respect to the rewards to be offered at this time, rewards corresponding to the ranks of users (the higher the rank, the greater the reward) are offered. When the reward is recorded as a token on the blockchain, it will be implemented as a fungible token on the blockchain (for example, ERC20 token of Ethereum or the like). For example, in such a case that a user's rank is offered as an item (title), it may be implemented as a unique and non-fungible token on the blockchain (for example, ERC721 token of Ethereum or the like).

### <1.3 Configuration of Distributed Ledger 31>

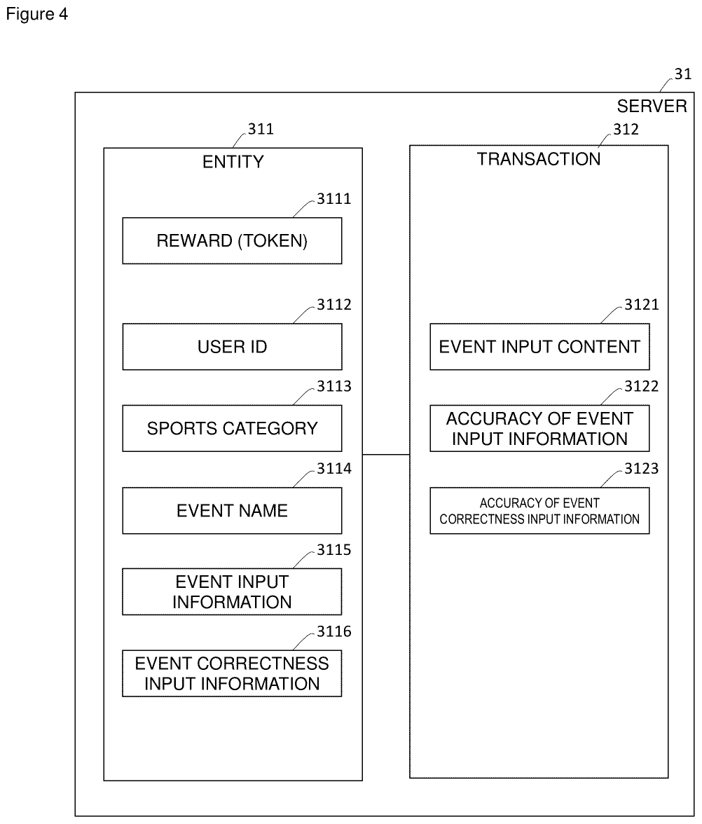

FIG. 4 is a conceptual diagram showing a content of the distributed ledger 31 constituting the event information distribution system 1 of the first embodiment. As shown in FIG. 4, the distributed ledger 31 includes entities and transactions. The entity represents a plurality of pieces of data, and the transaction is information representing an operation on those pieces of data. All of entity acquisitions and transactions are implemented as smart contracts on the blockchain.

Entities to which tokens are to be transferred and transactions involving the transfer of tokens between the respective entities exist on the blockchain. The entities include, for example, user IDs, sports categories, event names, event input information, and event correctness input information. Each entity is basically configured by minimum data such as an identifier and a time stamp, and data such as the relationship between identifiers, event input information, and event correctness input information are held on the blockchain.

The transaction includes, for example, an event input content, accuracy of event input information, accuracy of event correctness input information, and the like. With such a configuration, smart contract processing is performed between the user and a provider of the event information distribution system 1. Therefore, it is possible to surely provide rewards to users.

### <2 Data Structure>

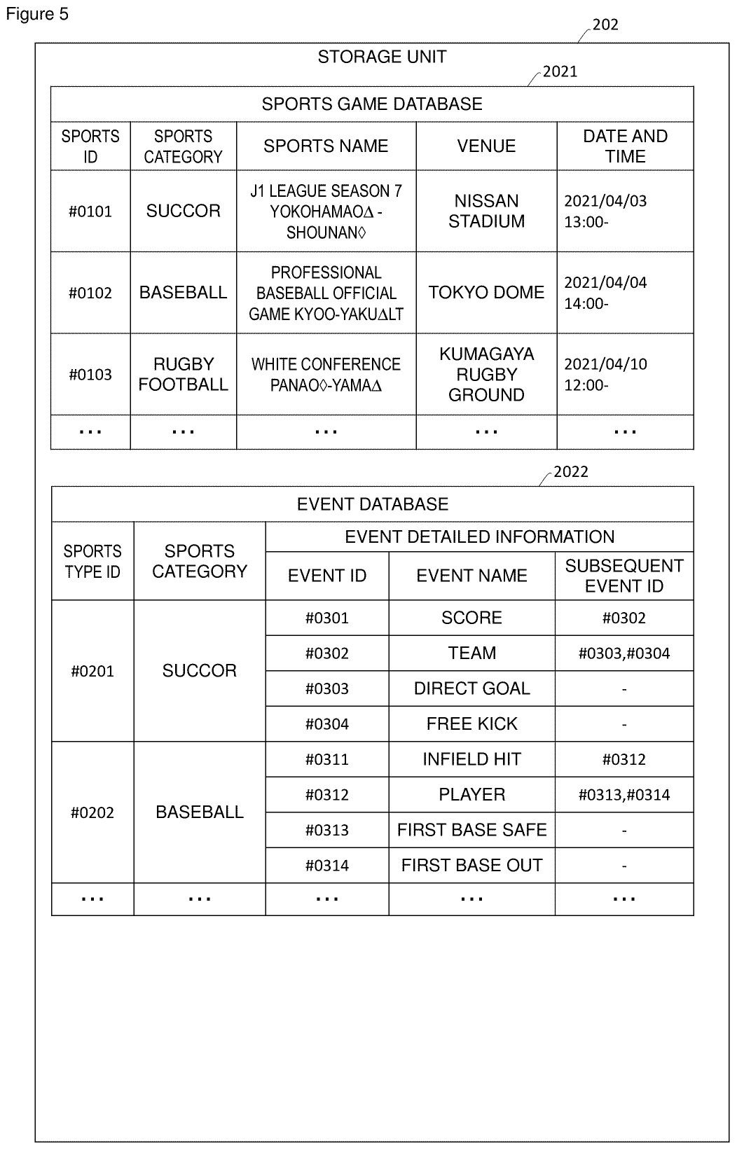

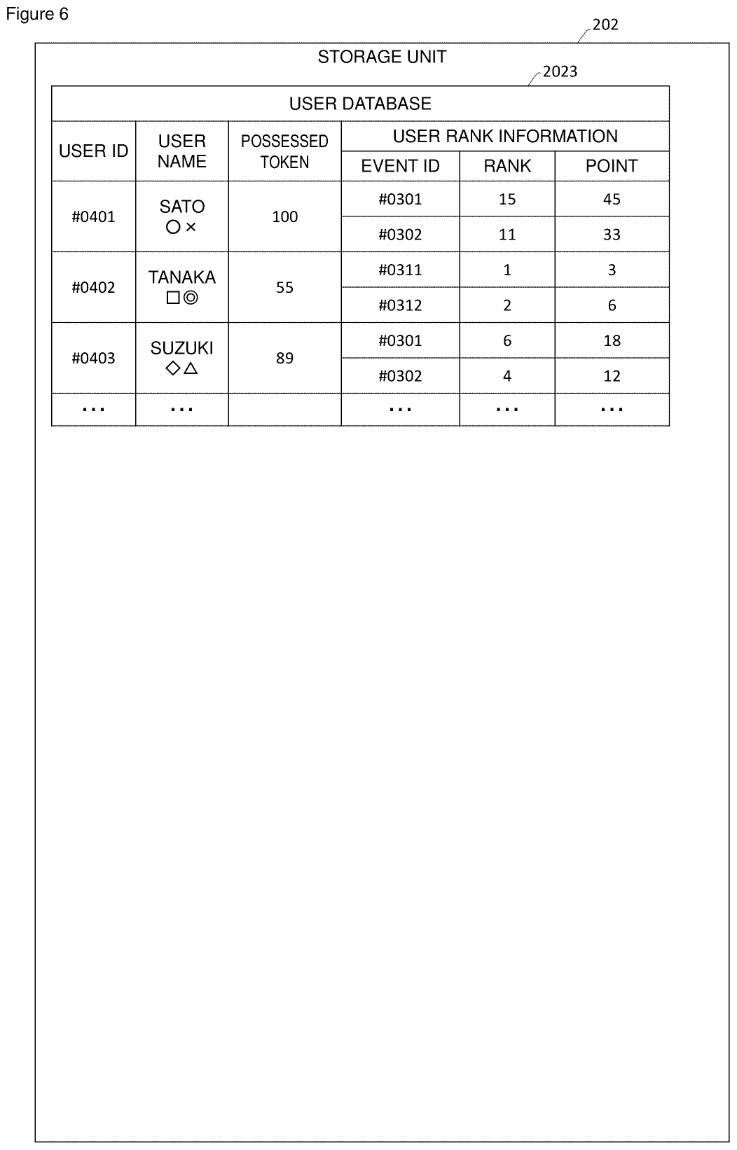

FIG. 5 is a diagram showing data structures of the sports game database 2021 and the event database 2022 stored by the server 20. FIG. 6 is a diagram showing a data structure of the user database 2023 stored by the server 20.

As shown in FIG. 5, each of records in the sports game database 2021 includes an item “event ID”, an item “sports category”, an item “event name”, an item “venue”, an item “date and time”, and the like.

The item “event ID” is information for identifying each of sports games for which event information is collected by the event information distribution system 1.

The item “sports category” is information indicating categories of sports games for which event information is collected by the event information distribution system 1. For example, information on category names of sports games such as an item “soccer” and an item “baseball” is stored.

The item “event name” is information indicating names of sports games for which event information is collected by the event information distribution system 1. For example, the information of the names of sports games (the names of sports events) such as the item “J1 League Season 7 Team A vs. Team B” is stored.

The item “venue” is information indicating places of venues where sports games stored in the item “event name” are held.

The item “date and time” is information indicating the dates and times when sports games stored in the item “event name” are held.

In the server 20, the sports game database 2021 is updated when information on a new sports game is acquired.

Each of records in the event database 2022 includes an item “sports type ID”, an item “sports category”, an item “event name”, an item “event detailed information”, and the like.

The item “sports type ID” is information for identifying each of categories of sports games for which event information is collected by the event information distribution system 1.

The item “sports category” is information indicating the categories of sports games for which event information is collected by the event information distribution system 1. For example, information on category names of sports games such as items “soccer” and “baseball” is stored.

The item “event detailed information” is information indicating the actions of players and teams and results caused by those actions in sports games for which event information is collected by the event information distribution system 1. Specifically, it includes an item “event ID”, an item “event name”, an item “subsequent event ID”, and the like.

The item “event ID” is information for identifying each piece of event information to be collected by the event information distribution system 1.

The item “event name” is information indicating names of event information to be collected by the event information distribution system 1, and for example, information such as “score”, “team”, and “direct goal” is stored.

The item “subsequent event ID” is information for identifying each piece of event information linked to event information indicated by the item “event ID”, and corresponds to the item “subsequent event ID”.

In the server 20, the event database 2022 is updated when new event information is acquired.

As shown in FIG. 6, each of records in the user database 2023 includes an item “user ID”, an item “user name”, an item “possessed token”, an item “user rank information”, and the like.

The item “user ID” is information for identifying each of users who have input event information in the event information distribution system 1.

The item “user name” is information indicating names of users who have input event information in the event information distribution system 1.

The item “possessed token” is information indicating amounts of possessed tokens which are rewards offered to users who have input event information in the event information distribution system 1.

The item “user rank information” is information related to the ranks of users who have input the event information in the event information distribution system 1. Specifically, it includes an item “event ID”, an item “rank”, an item “point”, etc.

The item “event ID” is information for identifying each piece of event information to be collected by the event information distribution system 1, and corresponds to the item “event ID” of the event database 2022.

The item “rank” is information indicating ranks given based on the accuracy of past event information of users who have input event information in the event information distribution system 1.

The item “point” is information indicating points given according to the ranks of users who have input event information in the event information distribution system 1.

Following update of users' ranks based on evaluation results of event information, the user rank update module 2037 of the server 20 updates the user database 2023. Further, following provision of rewards to users, the reward offering module 2038 updates the user database 2023.

### <3 Operation>

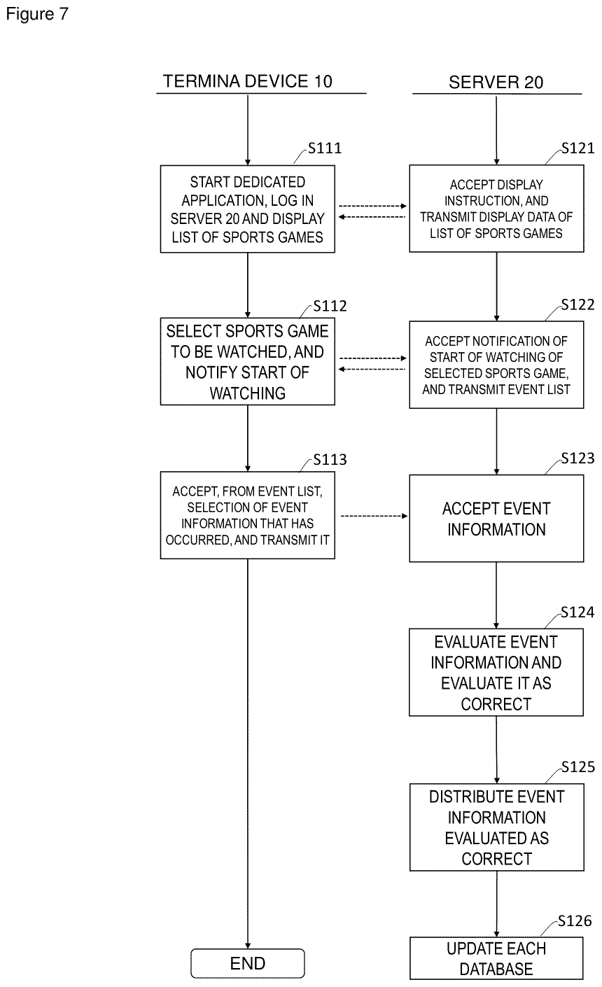

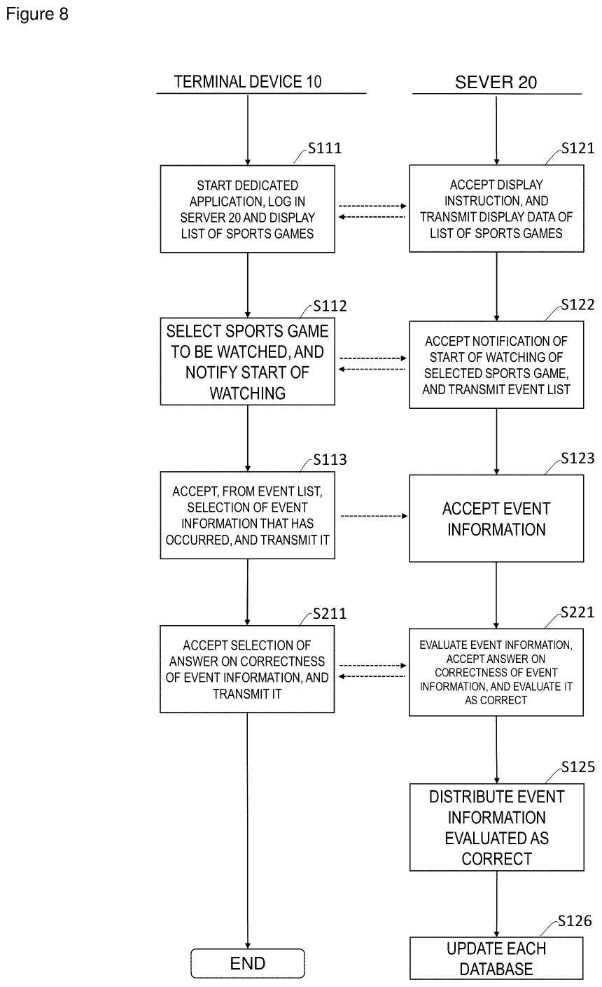

Event information distribution processing by the event information distribution system 1 according to the first embodiment will be described below with reference to FIG. 7 and FIG. 8.

FIG. 7 is a flow chart showing an example of a flow of the event information distribution processing by the event information distribution system 1 of the first embodiment.

In step S111, the input operation acceptance unit 181 of the terminal device 10 activates a dedicated application of the event information distribution system 1 according to a user's operation. The transmission/reception unit 182 transmits information (user ID, password, etc.) for accessing the server 20 to the server 20. The transmission/reception unit 182 receives instruction information for displaying a list of sports games and information on the list of the sports games transmitted from the server 20. The notification control unit 184 causes the display 132 to display the received information on the list of sports games.

In step S121, the server 20 receives a user ID and a password via the communication unit 201 to perform predetermined authentication, and receives access from the user. The sports game type identification module 2033 of the server 20 transmits the instruction information for causing the display 132 of the terminal device 10 of the user to display the list of the sports games stored in the sports game database 2021 and the information of the list of the sports games to the terminal device 10 through the communication unit 201.

In step S112, the input operation acceptance unit 181 of the terminal device 10 receives, from a user, an input for selecting a sports game from the displayed list of sports games. The transmission/reception unit 182 transmits the accepted selected sports game to the server 20. The transmission/reception unit 182 receives a notification of start of watching and the information on the list of event information that are transmitted from the server 20. The notification control unit 184 causes the display 132 to display the accepted notification of the start of watching, and notifies the user of the start of watching. The notification control unit 184 causes the display 132 to display the accepted list of event information, and starts to receive the event information.

At this time, in step S112, for example, the transmission/reception unit 182 of the terminal device 10 may receive captured image data which are obtained by imaging a competition situation from a drone, a camera or the like and transmitted from the server 20, or may acquire position information obtained from devices (NFC tags, Beacon devices, or the like) embedded in players' uniforms or the like to send position information, and transmit the position information to the terminal device 10 to present the position information to the user. In this case, the notification control unit 184 causes the display 132 to display the accepted captured image data and the position information.

In step S122, the sports game type identification module 2033 of the server 20 accepts selection of a sports game transmitted from the terminal device 10. The event information acceptance module 2034 notifies the user of the start of watching the sports game, and transmits the list of event information occurring in the sports game to the terminal device 10 via the communication unit 201.

In step S113, the input operation acceptance unit 181 of the terminal device accepts, from the user, an input for selecting event information occurred in the sports game from the list of event information displayed on the display 132. The transmission/reception 182 transmits the accepted event information to the server 20. This processing is performed at any time while the sports game is being performed.

In step S123, the event information acceptance module 2034 of the server 20 accepts event information transmitted from the terminal device 10. The event information to be accepted is information indicating the actions of players and teams in the sports game and the results caused by those actions. At this time, information on an event linked to one piece of event information selected by the user may be accepted.

At this time, in step S123, the event information acceptance module 2034 of the server 20 may analyze the captured image data obtained by imaging the competition situation from the drone, the camera or the like or analyze the position information obtained from the devices that are embedded in the players' uniforms to send the position information, predict the development of the competition using a machine learning model or the like based on the positions of the players and the like and the relationship thereof to predict events that may occur in the future, and present them as options to the user.

In step S124, the event information evaluation module 2035 of the server 20 evaluates whether the event information accepted in step S123 is the same as an event that actually occurred and whether the input event information is correct. Here, it is assumed that the event information evaluation module 2035 has collected event information from a plurality of users accepted in step S123 and the collection result has reached the first evaluation criterion. The event information evaluation module 2035 evaluates (establishes) the event information concerned as correct.

In step S125, the event information distribution module 2036 of the server 20 distributes the event information concerned because the event information concerned has been evaluated as correct in step S124.

In step S126, the user rank update module 2037 of the server 20 increases the points given to the users who have input the event information evaluated as correct in step S124, and ranks the users accordingly. The user rank update module 2037 updates the user database 2023 with respect to increased or decreased points and ranks. Further, the reward offering module 2038 of the server 20 provides prescribed rewards to the users who have input the event information evaluated as correct in step S124. The reward offering module 2038 updates the user database 2023 (or distributed ledger 31) with respect to the offered rewards.

As described above, the event information distribution system 1 accepts selection of a sports game from a user to identify the sports game, and accepts an input of event information from the list of event information. The event information is evaluated as to whether it is the same as the event that actually occurred, and when the event information is evaluated as correct, it is distributed. In the evaluation of event information, event information is collected from a plurality of users, and it is evaluated (established) that the event information is correct when the collection result has reached the first evaluation criterion. As a result, it is possible to efficiently collect and distribute information on sports games with accuracy secured by evaluation results.

FIG. 8 is a flowchart showing another example of the flow of the event information distribution processing by the event information distribution system 1 according to the first embodiment. In the event information distribution processing in the flowchart shown in FIG. 8, since step S211 and step S221 are added in place of the processing in step S124 as subsequent processing to steps S113 and S123 in the flowchart shown in FIG. 7, the duplicative processing is not repeatedly described.

In step S221, the event information evaluation module 2035 of the server 20 evaluates that the event information accepted in step S123 is the same as an event that actually occurred and that the input event information is correct. Here, it is assumed that the event information evaluation module 2035 has collected event information from a plurality of users accepted in step S123 and the collection result has not reached the first evaluation criterion. The event information evaluation module 2035 sends a question to the terminal devices 10 via the communication unit 201 as to whether the event information is correct or incorrect. The event information evaluation module 2035 accepts answers to the question sent from the terminal devices 10. Here, it is assumed that the event information evaluation module 2035 has collected the answers to the question from a plurality of users and the collection result has reached the second evaluation criterion. The event information evaluation module 2035 evaluates (establishes) the event information as correct.

In step S211, the transmission/reception unit 182 of the terminal device 10 accepts information on the question as to whether the event information concerned transmitted from the server 20 is correct or incorrect. The notification control unit 184 causes the display 132 to display the question as to whether the accepted event information concerned is correct or incorrect. The input operation acceptance unit 181 accepts an input of selecting an answer to the displayed question from users. The transmission/reception unit 182 transmits the accepted selection of the answers to the server 20.

As described above, in the evaluation of event information, the event information distribution system 1 collects the event information from a plurality of users, and transmits, to the users, a question as to whether the event information is correct or incorrect when the collection result has not reached the first criterion. The event information distribution system 1 collects information on answers to the question from a plurality of users, and evaluates (establishes) the event information as correct when the collection result has reached the second evaluation criterion. As a result, it is possible to efficiently collect and distribute information on sports games for which accuracy is secured by evaluation results.

### <4 Screen Example>

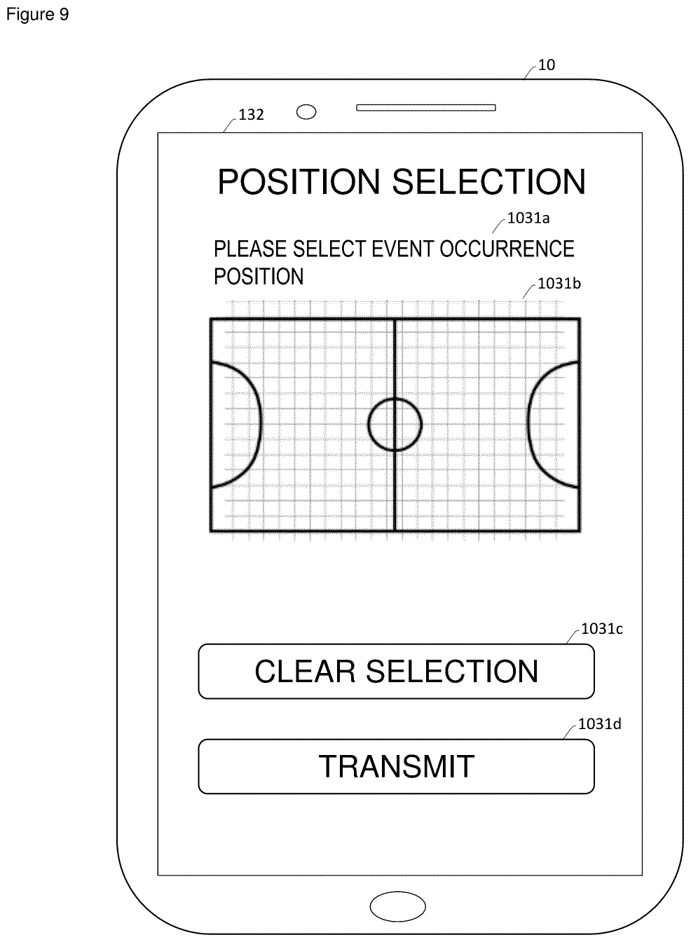

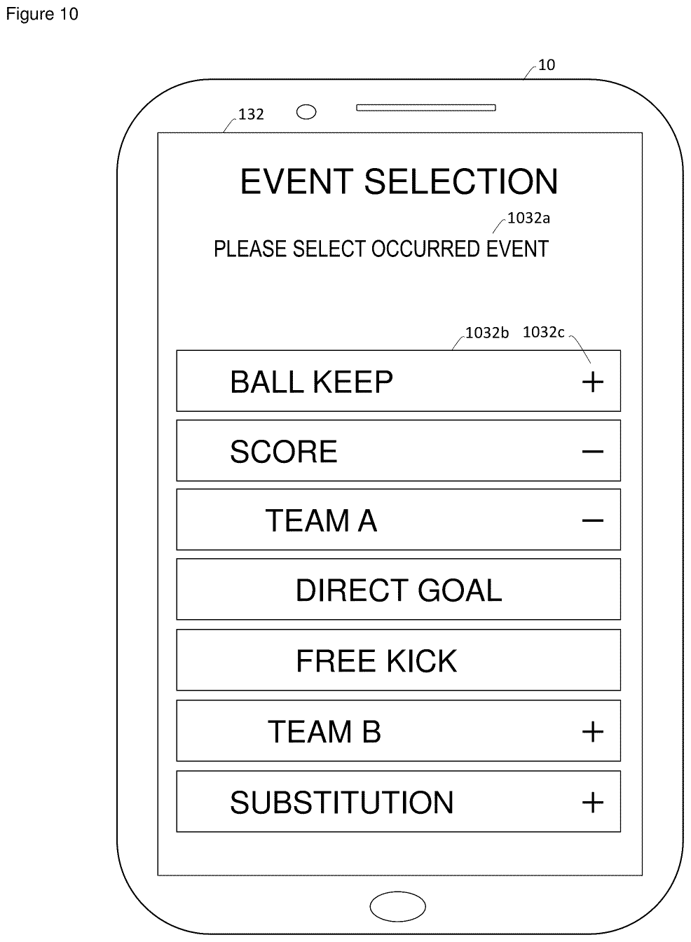

Screen examples of event information acceptance processing by the event information distribution system 1 will be described below with reference to FIG. 9 and FIG. 10.

FIG. 9 is a diagram showing an input screen example for an event occurrence position to be displayed on the terminal device 10. The screen example of FIG. 9 shows a screen example displayed for accepting the position where an event has occurred, with respect to event information to be accepted by the event information acceptance module 2034 of the server 20. This corresponds to step S113 in FIG. 7.

As shown in FIG. 9, an instruction display 1031a for prompting an input of the position where an event has occurred, and a field display column 1031b for accepting the input of the position where the event has occurred are displayed on the display 132 of the terminal device 10. Further, the display 132 of the terminal device 10 is provided with a clear button 1031c for clearing the selection to the field display column 1031b and a transmission button 1031d for instructing transmission of the selection to the field display column 1031b.

When transmitting event information that has occurred in a sports game, the user taps or the like on the field display column 1031b to select the position where the event has occurred. Thereafter, when transmitting, the user presses down the transmission button 1031d. This allows the user to transmit the event information (the place where the event has occurred) by a simple operation. Here, on the field display column 1031b, captured image data obtained by imaging the competition situation from a drone, a camera or the like or position information obtained from devices that are embedded in players' uniforms or the like for sending position information may be displayed.

FIG. 10 is a diagram showing an input screen example for event information displayed on the terminal device 10. The screen example of FIG. 10 shows a screen example displayed for accepting information (content) of an event with respect to event information to be accepted by the event information acceptance module 2034 of the server 20. This corresponds to step S113 of FIG. 7.

As shown in FIG. 10, an instruction display 1032a for prompting selection input of an event that has occurred, and an event selection display column 1032b for accepting selection of an event are displayed on the display 132 of the terminal device 10. Further, the event selection display column 1032b is provided with a subordinate display instruction button 1032c for displaying event information linked to the event.

When transmitting event information that has occurred in a sports game, the user taps or the like the event selection display column 1032b to select the event. At this time, when the subordinate display instruction button 1032c is provided for the event, event information linked to the event is displayed by pressing down the subordinate display instruction button 1032c, and the event is selected from the displayed event information by tapping or the like the event selection display column 1032b for the event. This allows the user to transmit event information by a simple operation.

### SUMMARY

As described above, according to the present embodiment, a list of sports games is presented to the user, and a sports game is identified by accepting selection of the sports game from the user. A list of event information is presented to the user, and an input for selection of event information from the user is accepted. This allows the user to transmit event information by a simple operation.

Further, it is evaluated whether accepted event information is the same as an event which actually occurred, and the event information is distributed users when the event information is evaluated as correct. In the evaluation of event information, event information from a plurality of users is collected, and when the collection result has reached the first evaluation criterion, the event information is evaluated (established) as correct. When the collection result has not reached the first evaluation criterion, a question as to whether the event information is correct or incorrect is transmitted to users. Information on answers to the question is collected from a plurality of users, and when the collection result has reached the second evaluation criterion, the event information is evaluated (established) as correct. As a result, it is possible to efficiently collect and distribute information on sports games for which accuracy is secured by evaluation results.

Furthermore, prescribed rewards are offered to users who have input event information evaluated as correct and users who have input answers on correctness for the event information evaluated as correct. This makes it possible to give incentives to users who have input accurate information, and expect them to input accurate information.

### Second Embodiment

Another embodiment of the event information distribution system 1 will be described below.

### <1 Overall Configuration of Event Information Distribution System 1>

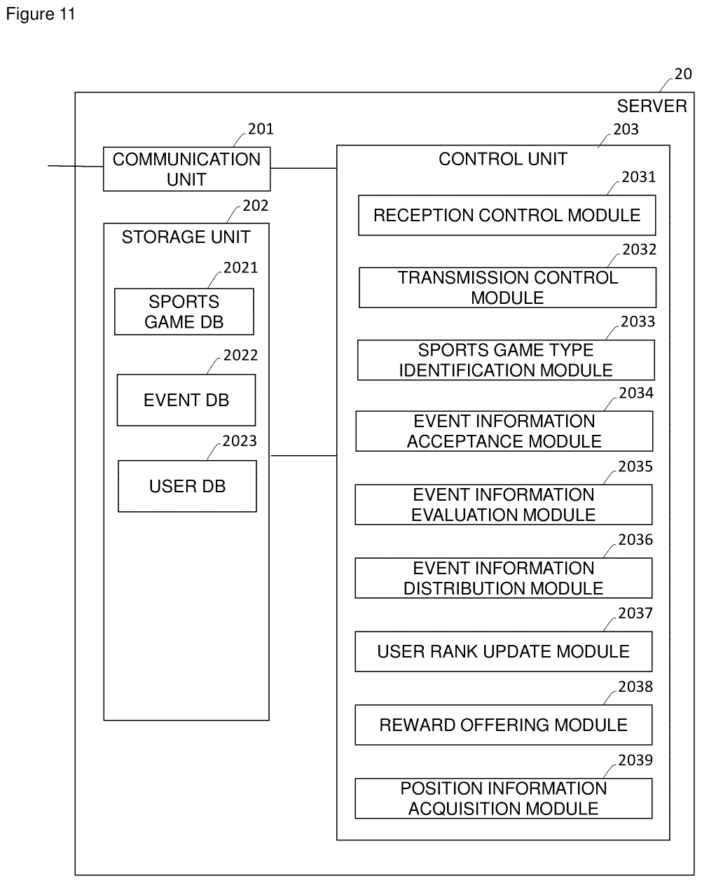

FIG. 11 is a diagram showing a functional configuration of a server 20 constituting an event information distribution system 1 of a second embodiment. The overall configuration of the event information distribution system 1 and the configuration of a terminal device 10 of the second embodiment are the same as those of the first embodiment, and they are not described repeatedly. The configuration of the server 20 is the same as that of the first embodiment except that the function of a position information acquisition module 2039 is newly added as the function of a control unit 203 as shown in FIG. 11. The function of the position information acquisition module 2039 according to the second embodiment will be described below.

The position information acquisition module 2039 controls processing for acquiring position information of the terminal device 10 which is detected by the position information sensor 150 of the terminal device 10. The position information to be acquired by the position information acquisition module 2039 is information on a current position of the terminal device 10 having the GPS module installed therein, which can be detected by the satellite positioning system.

A sports game type identification module 2033 in the second embodiment identifies a sports game which the user intends to watch, from the position information of the terminal device 10 acquired by the position information acquisition module 2039 and the current date and time by referring to information on sports games scheduled to be held, which is stored in the sports game database 2021.

### <2 Data Structure>

Since a data structure in the second embodiment is the same as that in the first embodiment, it is not described repeatedly.

### <3 Operation>

Since an operation in the second embodiment is the same as that in the first embodiment, it is not described repeatedly.

### <4 Screen Example>

Since a screen example in the second embodiment is the same as that in the first embodiment, it is not described repeatedly.

### <Summary>

As described above, according to the present embodiment, based on the position information detected by the terminal device, the information on the sports games scheduled to be held is referred to, and the sports game which the user intends to watch is identified. This allows the user to identify the sports game by a simple operation.

### Third Embodiment

Another embodiment of the event information distribution system 1 will be described below.

### <1 Overall Configuration of Event Information Distribution System 1>

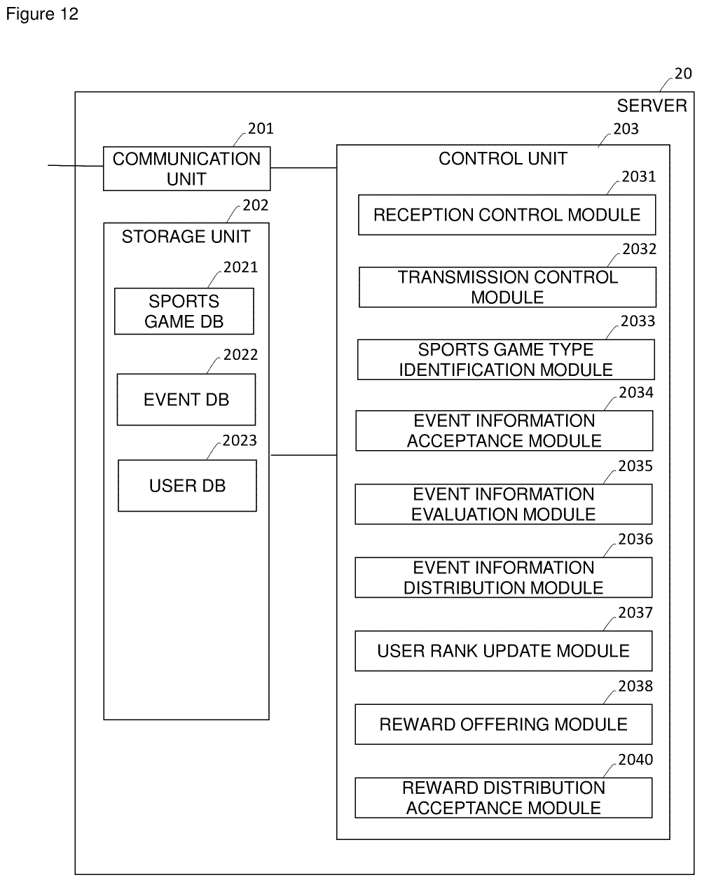

FIG. 12 is a diagram showing a functional configuration of a server 20 constituting an event information distribution system 1 of a third embodiment. Since the overall configuration of the event information distribution system 1 and the configuration of a terminal device 10 in the third embodiment are the same as those in the first embodiment, they are not described repeatedly. The configuration of the server 20 is the same as that of the first embodiment except that the function of a reward distribution acceptance module 2040 is newly added as the function of a control unit 203 as shown in FIG. 12. The function of the reward distribution acceptance module 2040 in the second embodiment will be described below.

The reward distribution acceptance module 2040 controls processing of accepting an input for distributing a reward owned by a user to a person concerned with a sports game, and transferring the user's reward to the person concerned with the sports game based on an accepted content. The person concerned with the sports game may be a specific person such as a player, a manager, a coach or the like who participated in the sports game, or may be the entire team. For example, the reward distribution acceptance module 2040 distributes the reward as tokens on the blockchain for an amount of a reward specified by the user. Further, the distribution of the reward to be accepted by the reward distribution acceptance module 2040 may be configured to be affected according to the rank of the user, and for example, a difference may be imposed on an upper limit of the distributable reward according to the user's rank, or a difference may be imposed on order of notification to the player.

### <2 Data Structure>

Since a data structure in the second embodiment is the same as that in the first embodiment, it is not described repeatedly.

### <3 Operation>

Since an operation in the second embodiment is the same as that in the first embodiment, it is not described repeatedly.

### <4 Screen Example>

Since a screen example in the second embodiment is the same as that in the first embodiment, it is not described repeatedly.

### <Summary>

As described above, according to the present embodiment, an input for distributing a reward owned by a user to a person concerned with a sports game is accepted and distributed. This makes it possible for the user to directly support a player or the like whom the user supports.

Although the disclosed embodiments have been described above, they can be implemented in various other forms, and can be implemented with various omissions, substitutions, and modifications. These embodiments, modifications, omissions, substitutions and changes are included in the technical scope of the claims and their equivalents.

### <Supplement>

The items described in each of the above embodiments are appended below.

(Supplement 1) A non-transitory computer readable medium that stores a program to collect and distribute information on sports games, processing of identifying a target sports game, processing of accepting an input of information on an event that has occurred in the sports game, from a terminal device of a user who is watching the sports game, processing of evaluating the accepted event information, processing of distributing the event information based on an evaluation result of the event information; and processing of offering a reward to a user who has input the event information, based on the evaluation result of the event information.

(Supplement 2) A non-transitory computer readable medium according in (Supplement 1), in which in the step of evaluating the event information, when a plurality of users at a ratio of not less than a predetermined ratio among a plurality of users have input the event information, the event information is evaluated as correct.

(Supplement 3) A non-transitory computer readable medium according in (Supplement 1), in which in the step of evaluating the event information, when it is determined that the event information from the plurality of users has reached a first evaluation criterion, the event information is evaluated as correct, whereas when it is determined that the event information from the plurality of users has not reached the first evaluation criterion, the processor 29 is caused to execute a step of accepting an input of answers on correctness for the event information from terminal devices of users who are watching the sports game, and when the answers on correctness for the event information from a plurality of users has reached a second evaluation criterion, the event information is evaluated as correct.

(Supplement 4) A non-transitory computer readable medium according in (Supplement 3), in which the program further causes the processor 29 to execute a step of ranking the users who have input the event information based on the evaluation result of the event information, and in the step of evaluating the event information, when it is determined that the event information from the plurality of users has reached the first evaluation criterion, and when it is determined that the answers on correctness for the event information from the plurality of users has reached the second evaluation criterion, the users are weighted according to user's rank, and determination is made.

(Supplement 5) A non-transitory computer readable medium according in (Supplement 4), in which the users who have input the event information are ranked on a sports game-type basis and on an event-type basis.

(Supplement 6) A non-transitory computer readable medium according in (Supplement 4), in which users who have input the event information are provided with points corresponding to ranks thereof, a first threshold value for determining a value calculated from points of a plurality of users who have input the event information is set as the first evaluation criterion, a second threshold value for determining a value calculated from points of a plurality of users who have input answers indicating that the event information is correct is set as the second evaluation criterion, and in the step of evaluating the event information, when the value calculated from the points of the plurality of users who have input the event information has reached the first threshold value, the event information is evaluated as correct, and when the value calculated from the points of the plurality of users who have input the answers indicating that the event information is correct has reached the second threshold value, the event information is evaluated as correct.

(Supplement 7) A non-transitory computer readable medium according in (Supplement 6), in which the program further causes the processor 29 to execute a step of increasing the points of the users who have input the event information evaluated as correct and the users who have input the answers indicating that the event information evaluated as correct is correct.

(Supplement 8) A non-transitory computer readable medium according in (Supplement 6), in which the program further causes the processor 29 to execute a step of decreasing points of users who have input event information evaluated as incorrect and users who have input answers indicating that event information evaluated as incorrect is correct.

(Supplement 9) A non-transitory computer readable medium according in (Supplement 4) to (Supplement 8), in which in the step of offering the rewards to the users who have input the event information, users who have input event information evaluated as correct and users who have input answers indicating that event information evaluated as correct is correct are provided with rewards corresponding to ranks of the users.

(Supplement 10) A non-transitory computer readable medium according in (Supplement 2), in which in the step of distributing event information, the event information evaluated as correct is distributed.

(Supplement 11) A non-transitory computer readable medium according in (Supplement 1), in which the memory stores information on sports games, and in the step of identifying a sports game, the information on the sports games is transmitted to a terminal device of a user and displayed so that the user can select the information, and the sports game is identified based on an input of selection by the user.

(Supplement 12) A non-transitory computer readable medium according in (Supplement 11), in which based on information on sports games which have been watched by users in the past, information on sports games is transmitted to terminal devices of the users and recommended to the users.

(Supplement 13) A non-transitory computer readable medium according in (Supplement 1), in which the memory stores information on places where and dates and times when sports games are held, the program further causes the processor 29 to execute a step of acquiring position information from a terminal device of a user who is watching a sports game, and in the step of identifying a sports game, the sports game is identified from the position information and current date and time by referring to the information on the place where and the data and time when the sports game is held

(Supplement 14) A non-transitory computer readable medium according in (Supplement 1), in which the memory stores event information corresponding to sports games, and in the step of accepting an input of event information, the event information is transmitted to a terminal device of a user and displayed so that the user can select the information, and an input of event information is accepted based on an input of selection by the user.

(Supplement 15) A non-transitory computer readable medium according in (Supplement 14), in which in the step of accepting input of event information, an input of one or more pieces of event information linked to one piece of event information selected by the user is accepted.

(Supplement 16) A non-transitory computer readable medium according in (Supplement 1), in which the program further causes the processor 29 to execute a step of accepting an input for distributing a reward for a user who has input event information to a person concerned with a sports game, and a step of transmitting information for transferring the reward for the user to the person concerned based on the input for distributing the reward for the user to the person concerned.

(Supplement 17) A non-transitory computer readable medium according in (Supplement 1), in which the reward for the user who has input the event information is recorded as a token on a blockchain.

(Supplement 18) A non-transitory computer readable medium according in (Supplement 1), in which the reward for the user who has input the event information is recorded as a value exchangeable for currency.

(Supplement 19) An information processing device includes a control unit 203 and a storage unit 202 and collects and distributes information on sports games, in which the control unit 203 executes a step (S122) of identifying a target sports game, a step (S123) of accepting an input of information on an event that has occurred in a sports game, from a terminal device of a user who is watching a sports game, a step (S124) of evaluating the accepted event information, a step (S125) of distributing the event information based on an evaluation result of the event information, and a step (S126) of offering a reward to a user who has input the event information, based on the evaluation result of the event information.

(Supplement 20) A method that is executed by a computer including a processor 29 and a memory 25 and collects and distributes information on sports games, in which, in the method, the processor 29 executes a step (S122) of identifying a target sports game, a step (S123) of accepting an input of information on an event that has occurred in a sports game, from a terminal device of a user who is watching a sports game, a step (S124) of evaluating the accepted event information, a step (S125) of distributing the event information based on an evaluation result of the event information, and a step (S126) of offering a reward to a user who has input the event information, based on the evaluation result of the event information.

1. A non-transitory computer readable medium that stores a program to collect and distribute information on sports games:
processing of identifying a target sports game;
processing of accepting an input of information on an event that has occurred in the sports game, from a terminal device of a user who is watching the sports game;
processing of evaluating the accepted event information; processing of distributing the event information based on an evaluation result of the event information; and
processing of offering a reward to a user who has input the event information, based on the evaluation result of the event information.

2. A non-transitory computer readable medium according to claim 1, wherein in processing of evaluating the event information, when a plurality of users at a ratio of not less than a predetermined ratio among a plurality of users have input the event information, the event information is evaluated as correct.

3. A non-transitory computer readable medium according to claim 1, wherein in processing of evaluating the event information, when it is determined that the event information from the plurality of users has reached a first evaluation criterion, the event information is evaluated as correct, when it is determined that the event information from the plurality of users has not reached the first evaluation criterion, processing of accepting an input of answers on correctness for the event information from terminal devices of users who are watching the sports game, and when the answers on correctness for the event information from a plurality of users has reached a second evaluation criterion, the event information is evaluated as correct.

4. A non-transitory computer readable medium according to claim 3, wherein in processing of ranking the users who have input the event information, based on the evaluation result of the event information, and in processing of evaluating the event information, when it is determined that the event information from the plurality of users has reached the first evaluation criterion, and when it is determined that the answers on correctness for the event information from the plurality of users has reached the second evaluation criterion, the users are weighted according to ranks thereof, and determination is made.

5. A non-transitory computer readable medium according to claim 4, wherein the users who have input the event information are ranked on a sports game-type basis and on an event-type basis.

6. A non-transitory computer readable medium according to claim 4, wherein users who have input the event information are provided with points corresponding to ranks thereof, a first threshold value for determining a value calculated from points of a plurality of users who have input the event information is set as the first evaluation criterion, a second threshold value for determining a value calculated from points of a plurality of users who have input answers indicating that the event information is correct is set as the second evaluation criterion, and in processing of evaluating the event information, when the value calculated from the points of the plurality of users who have input the event information has reached the first threshold value, the event information is evaluated as correct, and when the value calculated from the points of the plurality of users who have input the answers indicating that the event information is correct has reached the second threshold value, the event information is evaluated as correct.

7. A non-transitory computer readable medium according to claim 6, wherein in processing of increasing points of users who have input event information evaluated as correct and users who have input answers indicating that the event information evaluated as correct is correct.

8. A non-transitory computer readable medium according to claim 6, wherein in processing of decreasing points of users who have input event information evaluated as incorrect and users who have input answers indicating that the event information evaluated as incorrect is correct.

9. A non-transitory computer readable medium according to any one of claim 4, wherein in processing of offering the rewards to the users who have input the event information, users who have input event information evaluated as correct and users who have input answers indicating that the event information evaluated as correct is correct are provided with rewards corresponding to ranks of the users.

10. A non-transitory computer readable medium according to any one of claim 2, wherein in processing of distributing the event information, the event information evaluated as correct is distributed.

11. A non-transitory computer readable medium according to any one of claim 1, wherein the memory stores information of sports games, and in processing of identifying a sports game, the information on the sports games is transmitted to a terminal device of a user and displayed so that the user can select the information, and the sports game is identified based on an input of selection by the user.

12. A non-transitory computer readable medium according to claim 11, wherein based on information on sports games which users have watched in the past, information on sports games is transmitted to terminal devices of the users and recommended to the users.

13. A non-transitory computer readable medium according to any one of claim 1, wherein the memory stores information on places where and dates and times when sports games are held, the program further causes processing of acquiring position information from a terminal device of a user who is watching a sports game, and in processing of identifying a sports game, the sports game is identified from the position information and current date and time by referring to the information on the place where and the data and time when the sports game is held.

14. A non-transitory computer readable medium according to any one of claim 1, wherein the memory stores event information corresponding to sports games, and in processing of accepting an input of event information, the event information is transmitted to a terminal device of a user and displayed so that the user can select the information, and an input of event information is accepted based on an input of selection by the user.

15. A non-transitory computer readable medium according to claim 14, wherein in processing of accepting an input of event information, an input of one or more pieces of event information linked to one piece of event information selected by the user is accepted.

16. A non-transitory computer readable medium according to any one of claim 1, wherein the program further causes the processor to execute:
processing of accepting an input for distributing a reward for a user who has input event information, to a person concerned with a sports game; and
processing of transmitting information for transferring the reward for the user to the person concerned based on the input for distributing the reward for the user to the person concerned.

17. A non-transitory computer readable medium according to any one of claim 1, wherein the reward for the user who has input the event information is recorded as a token on a blockchain.

18. A non-transitory computer readable medium according to any one of claim 1, wherein the reward for the user who has input the event information is recorded as a value exchangeable for currency.

19. An information processing device including a control unit and a storage unit and collecting and distributing information on sports games, wherein the control unit executes:
identify a target sports game;
accept an input of information on an event that has occurred in the sports game, from a terminal device of a user who is watching a sports game;
evaluate the accepted event information; a step of distributing the event information based on an evaluation result of the event information; and
offer a reward to a user who has input the event information, based on the evaluation result of the event information.

20. A method that is executed by a computer including a processor and a memory and collects and distributes information on sports games, wherein, in the method, the processor executes:
identify a target sports game;
accept an input of information on an event that has occurred in the sports game, from a terminal device of a user who is watching a sports game;
evaluate the accepted event information; a step of distributing the event information based on an evaluation result of the event information; and
offer a reward to a user who has input the event information, based on the evaluation result of the event information.
